(19) United States
(12) Patent Application Publication
(10) Pub. No.: US 2014/0151299 A1
(43) Pub. Date: Jun. 5, 2014

(54) METHOD AND APPARATUS FOR CLEANING A MEMBRANE FILTRATION APPARATUS

(71) Applicant: newterra ltd., Brockville (CA)

(72) Inventors: Jason Downey, Ottawa (CA); Ulrich Weise, Loanggons (DE); Lutz Bohmerich, Pohlheim (DE); Johannus Witlox, Milton (CA)

(21) Appl. No.: 14/174,930

(22) Filed: Feb. 7, 2014

Related U.S. Application Data
(63) Continuation-in-part of application No. 13/570,385, filed on Aug. 9, 2012.

(51) Int. Cl. B01D 65/08; C02F 3/12; B01D 65/02

(52) U.S. Cl. CPC B01D 65/08; B01D 65/02; C02F 3/1273
USPC 210/636; 210/321.69

(57) ABSTRACT

A membrane filtration apparatus located in a filtration chamber has a number of membranes and an associated support structure having a plurality of input passages and output passages. Wastewater is delivered to the input passages at one side of the membranes and the output passages receive cleaned water at the other side of the membranes after it has passed through a membrane. Each of the input passages is open at top and bottom to the filtration chamber interior, but substantially closed laterally. In a method and apparatus for cleaning the filtration apparatus, gas bubbles are discharged into the wastewater below a first subset of the input passages to cause airlift induced circulation of the wastewater up through the first subset, the flow being directed across and down through a second subset of the input passages.

### CROSS REFERENCES TO RELATED APPLICATIONS

The present application claims is a continuation-in-part of U.S. patent application Ser. No. 13/570,385 entitled Method and apparatus for cleaning a filtration cassette of a membrane bio-reactor, and filed Aug. 9, 2012, the contents of which are incorporated herein by reference thereto.

### FIELD OF THE INVENTION

This invention relates to a method and apparatus for cleaning a filtration cassette and is particularly suitable for cleaning membrane filtration units forming part of a membrane bio-reactor (MBR) for treating wastewater.

### DISCUSSION OF RELATED ART

A membrane bioreactor (MBR) combines a membrane filtration process with a bioreaction process. The bioreaction process occurs within wastewater liquor contained within a chamber and the filtration process occurs at a membrane filtration cassette. In a suspended filtration cassette MBR, the filtration cassette is suspended in the bioreaction chamber, while in an external or sidestream MBR, the bioreaction process and the filtration process take place in separate chambers with the output from the bioreaction process being piped from the bioreaction chamber to the filtration chamber.

Membrane filtration units are widely used for municipal and industrial wastewater treatment. They may be large scale sewage installations having a typical capacity of 30 million gallons per day, municipal and industrial installations having a typical capacity of 150,000 gallons per day, or domestic units designed to be compact and economic and to have low management and servicing demands. Grey-water and wastewater treated using a high quality MBR can be used for toilet flushing, landscape irrigation/watering, vehicle washing/bathing and as general service water. MBR processing effectively neutralizes odor and substantially eliminates staining of ceramic and other surfaces. In this specification, the term “wastewater” means any water that has been adversely affected in quality by anthropogenic influence. It comprises liquid waste discharged from dwellings and commercial, industrial and agricultural sites and encompasses a range of contaminants and concentrations. It particularly includes municipal wastewater resulting from mixing wastewater from dwellings, businesses, industrial areas and storm drains. While membrane filtration units are useful for filtering water in applications which have biological content, they are also used for filtering of water without biological content such as storm water, river water and industrial wastewater.

A known form of suspended filtration plant has a filtration cassette consisting of a stacked series of filter packs mounted in a frame which is suspended in the bioreaction chamber. Each filter pack is configured as a generally vertically oriented plate with the stack extending horizontally. Each plate has a pair of flat ultrafine pore size membranes which flank and are welded to an intervening grid. The grid defines a series of receiving chambers which are connected to an outlet manifold. In use, a negative pressure is applied at the outlet manifold to stimulate the passage of wastewater from outside the filtration filter plates, across the membranes, into the receiving chambers and then to the outlet manifold. In the course of the passage of water though the membranes, particulate and bacterial content in the wastewater is filtered out. An MBR using this type of membrane stack is available from newterra ltd. under the trademark MICROCLEAR.® Other forms of suspended filtration units use membrane packs of different form: for example, tubular.

A problem with membrane filtration units, particularly prevalent in the case of MBR processes and equipment, is fouling. Membrane bio-fouling accumulates as a compressible coating on the membrane or in the membrane pores and is caused by deposition and/or absorption of organic and/or colloidal substances. The use of ultra-filtration membranes having pores that are much smaller than most micro-organisms, limits, but does not prevent, such membrane fouling. In a further blocking mechanism, inorganic matter precipitates onto the membranes as scaling. Scaling is primarily caused by hardness agents such as calcium and magnesium. Membrane fouling may result from any of a number of causes: for example, (a) adsorption arising from chemical attraction or reaction between materials dissolved in the wastewater and the membrane material, (b) membrane pore blockage if materials enter and lodge in the pores, (c) formation of a gelatinous film layer over pores, and (d) binding and growth of bacteria and other reaction products at the membranes. While membrane fouling will initially be somewhat localized, once started, small deposits that are not quickly removed will grow.

Fouling may also occur if screens used to pre-filter wastewater before it reaches the membrane filtration chamber are damaged or not properly installed. This can lead to the build-up of fibrous material such as hair at the base of membrane units. The fibrous material may eventually form a mat, with the mat then gathering grease to form a dense plug. The presence of such a plug can, over time, completely block wastewater passages in the filtration cassettes. Plugging of one passage halts the processing of wastewater from that passage. It may also place a heavier load on other wastewater processing passages for a set throughput which may not be optimal.

Regardless of whether the cause is fiber mats, scale, biological fouling, etc., the result is that the flux or throughput rate of the wastewater processing apparatus suffers. This can be compensated for to some extent by increasing the pressure differential across membranes. However, this is only a temporary solution because increasing the pressure difference firstly leads to more fouling material impinging on the membranes and secondly may damage the membranes. In addition, the processing plant becomes more expensive to run, because the pumps have to do more work to obtain the same throughput.

While membrane fouling and cassette blockage can be corrected by frequent chemical cleaning, this presents problems including additional cost, downtime of the filtration cassette, and formation of hazardous by-products. It is desirable therefore to minimize the potential for fouling during normal operation of a filtration unit.

A method for removing fouling at membrane surfaces and inhibiting its growth is air scouring, in which small air bubbles are caused to rise through the wastewater along membrane surfaces. The turbulence caused by the rising bubbles and their impact against particles and film on the membrane surfaces serve to discourage particulate and biofilm forming matter from lodging at the membrane surfaces. Shear forces produced by the air bubbles can be increased by periodically removing the manifold negative pressure to produce filtration pauses. Aeration cleaning may be reinforced during such pauses since particles on the membrane's surface are no longer encouraged to stay place by the normal suction pressure present during filtration.

While known arrangements for air scouring offer a valuable method of preventing fouling of membranes, improvements are possible in membrane cleaning methods and apparatus for extending operational periods between chemical cleaning.

### BRIEF DESCRIPTION OF THE DRAWINGS

For simplicity and clarity of illustration, elements illustrated in the following figures are not drawn to common scale. For example, the dimensions of some of the elements are exaggerated relative to other elements for clarity. Advantages, features and characteristics of the present invention, as well as methods, operation and functions of related elements of structure, and the combinations of parts and economies of manufacture, will become apparent upon consideration of the following description and claims with reference to the accompanying drawings, all of which form a part of the specification, wherein like reference numerals designate corresponding parts in the various figures, and wherein:

FIG. 1 is a perspective view of parts of a membrane bioreactor filtration cassette for use in a method and apparatus according to an embodiment of the invention.

FIG. 2 is a sectional view of apparatus according to an embodiment of the invention showing the apparatus in one operational cleaning phase.

FIG. 3 is a view corresponding to FIG. 2 showing the apparatus in a different operational cleaning phase.

FIG. 4 shows a sidestream MBR according to another embodiment of the invention.

### DETAILED DESCRIPTION OF THE INVENTION INCLUDING THE PRESENTLY PREFERRED EMBODIMENTS

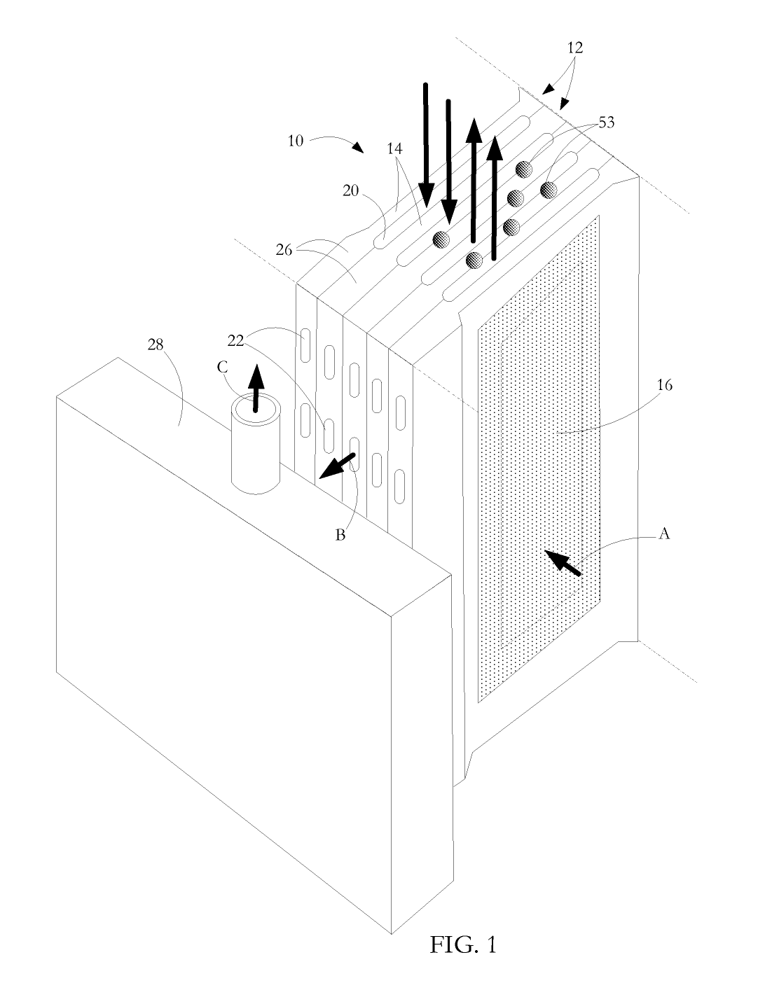

Referring to FIG. 1, there is shown part of a filtration cassette 10 for use in a membrane bioreactor (MBR) plant. The cassette 10 is a stacked series of filter packs 12. Each pack has a central plate 14 flanked by a pair of flat sheet-form ultrafine (UF) pore size membranes 16 which are welded to the plate 14. The plate has a matrix of internal receiving chambers (not shown) which are in fluid communication with vertical passages 20 and horizontal passages 22.

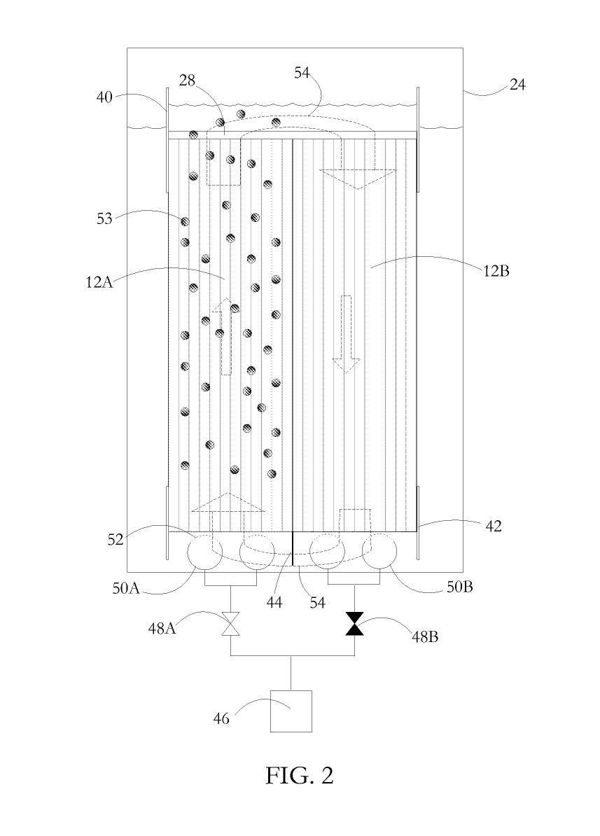

The passages 20 are located between adjacent packs 12 and vent to the interior of a filtration chamber 24 as shown in FIG. 2. Each passage 20 is confined laterally in the A direction by oppositely facing membranes 16 of adjacent packs 12, and is confined laterally in the B direction by thickened sections 26 of the plates, the thickened sections of adjacent packs 12 abutting each other. The horizontal passages 22 extend through the thickened sections 26 and provide fluid connection between the interior of the receiving chambers and an outlet manifold 28, which, in FIG. 1, is shown separated from the stacked filter plates to show filtrate flow (arrow B). The outlet manifold 28 also provides a supporting structure to fix the filter packs 12 in their stacked configuration as a cassette 10.

The arrangement shown in FIG. 1 is modular, with several packs 12 stacked together and forming the cassette 10. Several cassettes are typically mounted together to form a module (not shown), with modules being large or small depending on the required processing capacity.

In use, as shown in FIG. 2, filtration cassettes 10 are suspended in wastewater in the filtration chamber 24. Referring back to FIG. 1, a negative pressure is applied at the outlet manifold 28 to stimulate the migration of wastewater into the passages 20, across membranes 16, into the interior receiving chambers, through the horizontal passages 22, and out into the outlet manifold 28.

In the course of the passage of wastewater though the membranes 16, particulate, and bacterial content in the wastewater is filtered out and remains in the wastewater concentrate surrounding the filter plates 14. This eventually collects as sludge in the filtration chamber 24. When the sludge reaches a predetermined concentration, it is pumped out of the filtration chamber. Cleaned water filtrate is removed (arrow C) at the outlet manifold 28 to be replaced by more wastewater to be treated which is piped into the filtration chamber 24.

The individual membrane filter plates 14 are shaped so that when configured as a stack, the vertical passages 20 exist between one membrane 16 of one pack 12 and the facing membrane of the next adjacent pack. The passages 20 allow circulation of wastewater contained in the filtration chamber 24. The wastewater circulates past the membranes 16 and as it does so, part of it is caused by the differential pressure across the membranes 16 to pass through the membranes and into the chambers, being cleaned as it does so. The passages 20 are also important for membrane cleaning as will be described presently.

In the illustrated embodiment, the filtration chamber 24, as well as housing the filtration cassettes bolted or welded together as a module, also functions as a bioreactor chamber in which a chemically inert medium is maintained, the medium acting as a host for bacteria which feed on and break down organic material in the wastewater. Aerators may be used to inject oxygen into the wastewater to accelerate the bacteria feeding action. In addition, mixers may be used to agitate the reactor contents to increase the rate at which the bacteria and the organic materials come into contact and interact. Temperature and other conditions of the bioreactor chamber are carefully controlled so as to encourage and maintain the bacteria population as cleaned water is removed from the filtration cassette and replacement wastewater is added to the chamber.

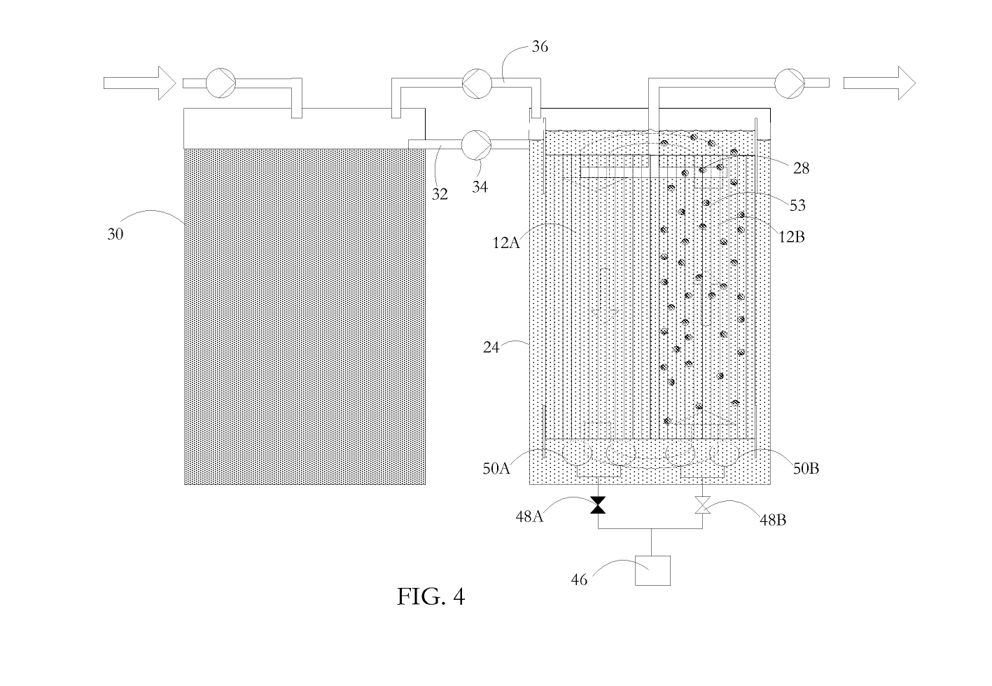

In an alternative embodiment of the invention as illustrated in FIG. 4, wastewater concentrate within the filtration chamber 24 is relatively biologically inactive. Primary bioreaction in the wastewater occurs in a preceding bioreaction chamber 30, with an output from the upstream bioreactor being driven through pipe 32 by pump 34 as less biologically active wastewater to the filtration chamber. In operation, wastewater is pumped into the filtration chamber 24 at a higher rate than filtrate is removed from the interior of the membrane filtration cassette 10. Excess water within the filtration chamber 24 is taken back through pipe 36 to the upstream bioreactor tank 30 to ensure that the wastewater in the filtration chamber 24 does not become excessively thickened by the accumulation of sludge. In the sidestream embodiment, excess sludge is removed from the upstream bioreactor chamber 30, with the cycling back of excess wastewater from the filtration chamber 24 ensuring that the sludge concentration is maintained at a low level in the filtration chamber. Other forms of suspended MBR applicable to the invention may use membranes of different form, such as tubular membranes.

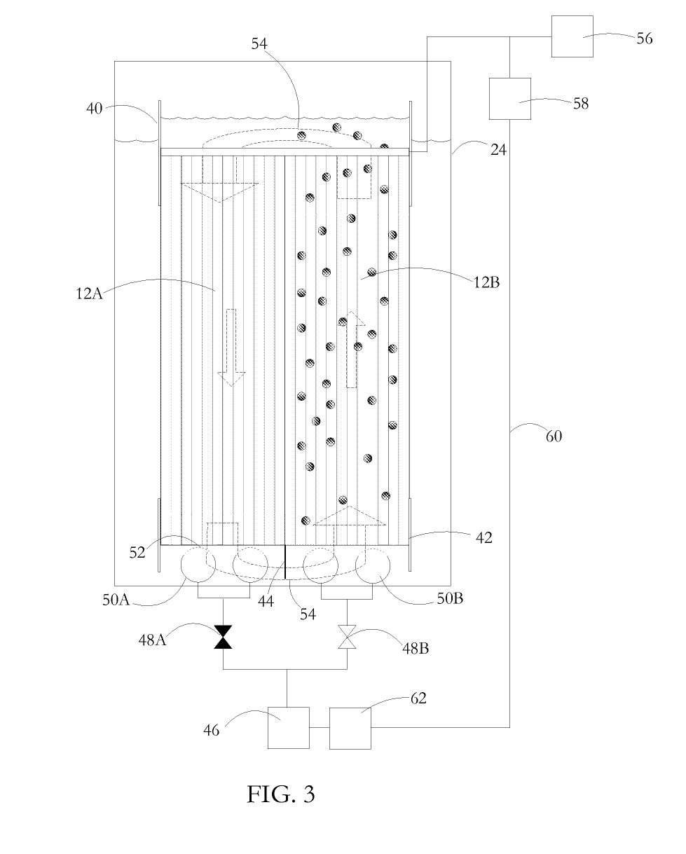

Referring back to FIGS. 2 and 3, there is shown MBR apparatus having a bioreactor filtration chamber housing cassettes 10 of the type illustrated in FIG. 1. The filter cassettes include a first cassette comprising a set 12A of vertically orientated packs shown at the left in FIG. 2 and a second cassette comprising a set 12B of vertically orientated filter packs shown at the right. The first and second filter pack sets 12A, 12B are separated by an intermediate wall 38, although such a wall is not essential in the exemplary flat plate membrane pack arrangement because the bounding membranes where the two sets 12A, 12B meet act as a confining boundary between the filter pack sets. At the top of the filter pack sets, a shroud 40 surrounds the exterior of the module 10. Another shroud 42 surrounds the exterior of the module 10 at the bottom of the filter packs 12, the bottom shroud 42 having a central separation baffle 44. The cassette 10 is mounted within the filtration chamber 24 by a suitable mounting arrangement (not shown) such that there is clearance between the bottom of the apparatus and the floor of the filtration chamber to provide space for sludge to settle and to permit access for removing it. The clearance also allows wastewater to come in from perimeter as needed to satisfy water flow demand in the up flow filter pack set 12A.

The MBR apparatus includes an air supply sub-system including an air supply 46, valves 48A, 48B, and air diffuser pipes 50A, 50B. The diffuser pipes 50A, 50B are positioned beneath respective filter pack sets, 12A, 12B and are connected to respective valves 48A, 48B. The diffuser pipes 50A, 50B have small holes 52 distributed along their tops allowing the escape of pumped air as air bubbles 53 which rise upwardly into the passages 20. Air escape holes may additionally punctuate the side and/or bottom of the pipes with the particular configuration of pipes and holes selected to provide a relatively uniform flow of bubbles 53 into the passages 20.

In operation, in a first cleaning phase, valve 48A is opened so that air pumped into pipe diffusers 50A causes the discharge of air bubbles 53 under the filter pack set 12A. In the first cleaning phase, the valve 48B is closed. In a second cleaning phase, valve 48B is opened so that air pumped into pipe diffusers 50B causes the discharge of air bubbles 53 under the filter pack set 12B. In the second cleaning phase, the valve 48A is closed.

In the first cleaning phase as illustrated in FIG. 2, as bubbles rise up through the wastewater in the passages 20 of filter pack set 12A, they cause an air lift of the wastewater which consequently rises up though the filter packs 12A. The airlift causes the water level above filter pack set 12A inside the shroud 40 to rise above the surrounding level of the filtration chamber 24. The water at the top of the passages of filter pack set 12A exits the passages 20 and, because it is constrained by the shroud 40, can flow only across to a zone above the passages of the other filter pack set 12B. There is no air coming up the passages of the filter pack set 12B because the valve 48B is off so there is no airlift of wastewater in the filter pack set 12B. Consequently, the water from passages 20 of filter pack 12A flows down the passages 20 of filter pack set 12B and out into the surrounding wastewater in the filtration tank 24 as the levels of water within the shroud 40 and in the outer part of the filtration tank 24 tend to equalize. As the airlift continues to generate in the filter pack set 12A, a water circulation pattern illustrated by arrows 54 is generated. In this circulation pattern, wastewater and air bubbles flow up through the passages of the filter pack set 12A and wastewater flows down through the passages of the filter pack set 12B. The shroud 40 acts essentially as a director to direct water escaping from the top of the passages 20 of the first filter pack set 12A into the top of passages 20 of the second filter pack set 12B.

The combination of the upward flow of wastewater past the membranes of the filter pack set 12A and the movement of bubbles upwardly along the membrane surfaces of the filter pack set 12A inhibit the deposition of fouling such as scale and biofilm and, to some extent, strips from the membrane surfaces fouling material that has already started to accumulate. The bubbles work through two primary mechanisms. Firstly, air bubbles collide with particles or film adhering to the membrane surface and knock off particles or tear away parts of accreted surface film. In a second effect, as the bubbles pass along the surface of the membrane, they displace water. The displaced water flows relatively downwardly around the bubble as the bubble floats on upwardly. This results in eddy currents in the water which act to wash particles and film from the membrane surface.

Even though there are no scouring bubbles in the filter pack set 12B in the first cleaning phase, the downward flow of wastewater through the passages 20 of filter pack set 12B has some effect in cleaning the membrane surfaces that laterally confine the passages 20 of that set, simply by the turbulent passage of water along the membrane surfaces. The downward flow also has the effect of flushing out any plugs of fibrous mat and grease that may have accumulated from a previous flow of wastewater and bubbles up through the passages 20 of the filter pack set 12B in the course of a prior cleaning phase as described below. Because water flow in the vertical passages of the filter pack set 12B is in a downward direction, shear forces are developed that attack deposited fouling particles and film from a different direction and may shear this off the membrane if the deposit is more susceptible to downward flow than upward flow. Generally the cleaning effect achieved by moving the water is more a result of preventing solids from attaching to the membranes than shearing off previously accreted fouling. Applying forces to the particles and keeping them moving reduces the chance of the particles adhering to the membrane and preventing subsequent scouring. It appears that in many configurations, airlift induced water flow, both upward and downward, is often the primary preventative of membrane fouling, even when air bubble scouring is present.

In a second cleaning phase as illustrated in FIG. 3, the valve 48A is closed and the valve 48B is open and a reverse circulation flow and fouling removal activity develops. In operation, there is a continuous cycling between the two bubbling/circulation modes with a periodicity set to optimize prevention and/or removal of fouling.

The bubble size and rate of release in each cleaning phase can be optimized for (a) inhibiting expected deposition material, (b) the mesh size and strength of the membranes, and (c) the flux rate across the membrane. The release of air bubbles can be tuned to the expected nature and size of fouling deposits. For example, the rate of flow of air into the selected release pipes can be raised or lowered until optimal scouring is observed. Also, larger or smaller bubbles can be generated using appropriately sized holes in the diffuser pipes. In addition, bubbles having a range of sizes can be developed. The tuning of bubble conditions may be set either from the viewpoint of the dynamics of bubble movement and collisions with the membranes, or from the viewpoint of changing the speed of water airlift along the surfaces of the membranes as described below. In addition, both of these may be varied over time in order to subject any nascent deposit to varied scouring effects.

FIG. 3 shows a feedback control device which can usefully be deployed with a bubbling method and apparatus according to the present invention. The apparatus includes a filtrate withdrawal pump 56, a monitoring device 58 to monitor pressure across the membranes and to transmit an indication of the measured pressure on a feedback link 60 to a variable control device 62 for controlling the rate of flow from the pump 46 into the diffuser pipes 50A, 50B. The feedback control enables a reduction in the amount of air being pumped to match a reduced transmembrane pressure or to match throughput of the MBR processing apparatus when it is not being operated at full capacity. This assists in lowering the cost of operation.

As mentioned above, the bubble size and rate of release in each cleaning phase can alternatively or additionally be optimized for maximizing airlift in one filter pack set in order to achieve a desired water pressure at the bottom of the passages of the other filter pack set to dislodge accumulated plugs of fiber and grease. The air flow into the diffuser pipe and the hole density and size are chosen to develop a desired circulation flow and, with the flow, an associated pressure of wastewater driven into and down the passages. The rate and nature of wastewater flow down the passages may also be altered or tuned to inhibit or remove, to some extent, material deposited on the membranes.

While, in the embodiment of the invention illustrated in FIGS. 2 and 3, the shroud 40 acts essentially as a director to direct water exiting the top of one set of the vertical passages into the top of an adjacent set of vertical passages, a different form of director could be used. For example, first and second manifolds (not shown) are located over the top of the first and second filter packs respectively, with the manifolds having an interconnecting conduit at an appropriate level to capture airlifted water from the filter pack set being subjected to bubbling. In use, in the first cleaning phase, airlifted water from one set of the passages enters the first manifold and flows across the conduit to the second manifold from where it flows down the passages of the filter pack set as the levels of water at the top of the first filter set and the surrounding filtration chamber tend to equalize. Subsequently, the arrangement is subjected to a reverse process, with the flow of wastewater passing in the opposite direction through the connecting conduit. In a further alternative, the director is at the bottom of the cassettes, the bottom shroud acting to direct water directed down through one of the cassettes across and up through an adjacent cassette through which bubbling occurs.

Whereas in the embodiment shown, in any particular cleaning phase, there is a region where wastewater is airlifted, in a modified apparatus particularly for larger modules, there may, in a particular cleaning phase, be several regions where wastewater is airlifted by bubbling and several corresponding regions where wastewater is descending. In such an arrangement, the “up” and “down” regions can be configured as dedicated pairs by appropriately configuring the associated wastewater directors. Alternatively, the directors can be configured so as to direct airlifted wastewater from an “up” region into several “down” regions. Depending on the operating performance or other factors of multiple up-down cassettes within a processing plant, the rate and nature of bubble delivery can be tailored to particular cassettes and can be tailored also to areas within a particular cassette.

While the filtration cassette described previously consists of a series of flat plate filter packs that are bonded together, other structures utilizing filter membranes can be used provided that the membrane filter packs are generally vertically disposed and spaced to allow wastewater and bubbles to flow upwardly and water downwardly in passages along the membrane surfaces and provided also that by selection of bubble release location, the wastewater can by way of airlift be caused to circulate to cause upward bubble/wastewater flow through certain selected passages past associated membrane surfaces with wastewater flowing downwardly through other passages past other associated membrane surfaces. Membrane modules may otherwise have any of a variety of shape and cross-sectional areas suitable for use in a desired filtration application.

In the illustrated embodiment, an “up” cassette is located immediately adjacent a “down” cassette. Multiple cassettes may be configured as a module, with the module being large or small depending on desired processing capability. In fact, the filter packs may be mounted other than in the manner of a discrete cassette. For example, a basic unit according to one embodiment of the invention comprises one up filter pack and one down filter pack and a filtration module can be made up of any combination or permutation of such basic units.

The membranes may be made of any material (natural or synthetic) that provides desired filtration dynamics. The membrane packs may be mounted directly to the chamber walls or floor or may be mounted at support frame which may be removably attached to the chamber to facilitate removal of membrane packs for chemical cleaning, other maintenance, and replacement.

Whereas to maximize the airlift induced circulation of wastewater, the membrane filtration packs are ideally mounted in a vertical orientation, the two cleaning phases can be achieved even if the filtration packs are mounted off-vertical provided that the buoyancy of the bubbles in each cleaning phase can deliver the desired airlift induced circulation of wastewater.

While in the preferred embodiment illustrated, air is used to scour in the first cleaning phase and to air lift in the second cleaning phase, a different gas can be used, for example, if anaerobic conditions are desired in the filtration chamber or if the gas has special properties in terms of removing or preventing the deposition of scaling or biofouling. Use of such a gas can be in combination with air or as a substitute for it and can be a constant or intermittent use.

Because filtration cassette blockage and fouling of membranes are relatively pervasive problems, other techniques exist for inhibiting or removing fouling during normal operations of a filtration cassette. The two phase cleaning method and apparatus of the present invention can be used in conjunction with such other compatible operational cleaning techniques. One example is backwashing, a process in which, by applying pressure on the filtrate side that is higher than the pressure within the wastewater, filtrate is flushed back through a membrane to the wastewater side to flush out the membrane pores from inside the pack. The bubbling technique can be performed during normal operation of the MBR filtration cassette or can be performed when the cassette is not being operated: i.e. there is no flow of wastewater from inlet across the membranes to the outlet manifold. The value of having multiple methods for removal of fouling is that fouling is essentially dynamically attacked from several different directions meaning that the most vulnerable anchor direction of a fouling particle or film is more likely to be attacked.

Other variations and modifications will be apparent to those skilled in the art. The embodiments of the invention described and illustrated are not intended to be limiting. The principles of the invention contemplate many alternatives having advantages and properties evident in the exemplary embodiments.

What is claimed is:

1. A method of cleaning a filtration apparatus having a plurality of membranes and a membrane supporting structure within a filtration chamber, the membranes and the supporting structure defining a plurality of input passages and output passages, the input passages delivering wastewater to one side of the membranes, the output passages receiving cleaned water at the other side of the membranes after the wastewater has been cleaned following passage through the membranes, each of the input passages open at top and bottom to the interior of the filtration chamber and substantially closed laterally, the method comprising, in a first cleaning phase, discharging gas bubbles into the wastewater below a first subset of the input passages to cause airlift induced circulation of the wastewater up through the first subset of input passages and across and down through a second subset of the input passages.

2. A method as claimed in claim 1, further comprising in a second cleaning phase, discharging gas bubbles into the wastewater below the second subset of input passages to cause airlift induced circulation of the water up through the second subset of input passages and across and down through the first subset of input passages.

3. A method as claimed in claim 1, the input passages substantially closed laterally by at least one membrane.

4. A method as claimed in claim 3, the input passages further closed laterally by a part of the supporting structure.

5. A method as claimed in claim 1, wherein the gas is air.

6. A method as claimed in claim 1, comprising pumping gas to first and second discharge zones respectively below the first and second input passage subsets from a common source, and operating valve to select one or other of the discharge zones.

7. A method as claimed in claim 1, the rate of gas discharge and bubble size selected for effective membrane scouring.

8. A method as claimed in claim 1, the rate of gas discharge and bubble size selected for effective air lift of the wastewater.

9. A method as claimed in claim 1, wherein the membrane filter packs are sandwich form plates, each having a pair of membranes flanking a central support member, the support member having interior chambers for receiving cleaned wastewater passing through the membranes, the chambers in fluid communication with the outlet passages.

10. A method as claimed in claim 9, the filter plates being rectangular.

11. A method as claimed in claim 1, the filtration chamber and its contents configured to function as a bioreactor chamber.

12. A method as claimed in claim 1, further comprising pumping wastewater from a bioreactor chamber to the filtration chamber.

13. Apparatus for cleaning a filtration unit having a plurality of membranes and a membrane supporting structure within a filtration chamber, the membranes and the supporting structure defining a plurality of input passages and output passages, the input passages for delivering wastewater to one side of the membranes, the output passages for receiving cleaned water at the other side of the membranes after the wastewater has been cleaned by passing through the membranes, each of the input passages open at top and bottom to the interior of the filtration chamber and substantially closed laterally, a first gas discharge mechanism for discharging gas bubbles into the wastewater below a first subset of the input passages to cause airlift induced circulation of the wastewater up through the first subset of input passages, and a director for directing airlifted wastewater from the top of the passages of the first filter pack set and across and down through a second subset of the input passages.

14. Apparatus as claimed in claim 13, further comprising a second gas discharge mechanism for discharging gas bubbles into the wastewater below the second subset of input passages to cause airlift induced circulation of the wastewater up through the second subset of input passages, said director for directing the airlifted wastewater from the top of the passages of the second filter pack set and across and down through the first subset of input passages.

15. Apparatus as claimed in claim 13, the membranes forming parts of a plurality of filter packs, the director being a shroud extending around the plurality of filter packs at the top thereof, the shroud providing isolation of wastewater in the tops of the filter packs from wastewater in a surrounding part of the filtration chamber.

16. Apparatus as claimed in claim 14, further comprising a pumping sub-system, operable in a first cleaning phase to pump gas to the first discharge mechanism but not the second discharge mechanism, and operable in the second cleaning phase to pump gas to the second discharge mechanism but not the first discharge mechanism.

17. Apparatus as claimed in claim 14, the discharge mechanisms including gas diffusers under the input passages, the diffusers having arrays of holes for releasing bubbles from the diffusers into the wastewater.

18. Apparatus as claimed in claim 17, further comprising a lower shroud extending around the plurality of filter packs at the base thereof, the lower shroud having a dividing wall to confine bubble discharge from a first subset of diffusers to the first subset of passages and to confine bubble discharge from a second subset of diffusers to the second subset of passages.

19. Apparatus as claimed in claim 16, further comprising an adjustment means in the pumping sub-system for selecting a rate of gas discharge to the discharge mechanisms.

20. Apparatus as claimed in claim 13, the membranes forming parts of a plurality of filter packs, the filter packs each being of sandwich form having a pair of membranes flanking a central support member, the support member having interior chambers for receiving cleaned water following passing of wastewater through the membranes, the interior chambers in fluid communication with the outlet passages.

21. Apparatus as claimed in claim 20, the filter plates being rectangular.

22. Apparatus as claimed in claim 13, the filtration chamber configured to function as a bioreactor chamber.
